(19) United States
(12) Patent Application Publication
(10) Pub. No.: US 2010/0257487 A1
(43) Pub. Date: Oct. 7, 2010

(54) Internet/Computer/Website based system and method for property operations and maintenance

(75) Inventor: Michael W. Jackson, China Spring, TX (US)

Correspondence Address: Galasso & Associates, LP, P.O. Box 26503, Austin, TX, 78755-0503, US

(73) Assignee: MWJ CONSTRUCTION GP, INC.

(21) Appl. No.: 12/384,323

(22) Filed: Apr. 2, 2009

(51) Int. Cl. G06F 3/048; G06F 17/30

(52) U.S. Cl. 715/855; 707/E17.059

(57) ABSTRACT

A system and method for electronically storing and accessing information related to the maintenance and operations of a building or other structure is described. The system involves a database at a server capable of being updated to store information related to a property such as contacts, installation dates, warranties and user manuals for equipment and features at a property and an end user terminal capable of displaying a secured website and navigable maps that allow selection of other features, locations, products or areas of interest of a building, structure or site to obtain the stored information in the database. The method involves storing information related to a property at a central database in a server that is protected via password and accessing the information from an end user terminal which permits display and use of navigable maps showing areas of interest at the property.

### CROSS REFERENCE TO RELATED APPLICATIONS

This United States non-provisional patent application does not claim priority to any United States provisional patent application or any foreign patent application.

### FIELD OF THE DISCLOSURE

The disclosures made herein relate generally to a system and method for property operations and management. More specifically, the invention described herein involves a system and method for storing and accessing information related to maintenance and operations of a building or other structure.

### BACKGROUND

Even small construction projects often require the use of numerous contractors, sub-contractors, craftsman and workers to complete the myriad of tasks necessary to create a fully operational building or other structure. It is common for different entities to be involved in various projects in and around the structure such as installing exterior and interior lighting, wiring, landscaping, plumbing, and storm drainage. A wide array of materials and products are used for railings, roofing, tiling, masonry work, gutters, shingles, exhaust units, windows, doors, hardware, cabinetry and other fixtures. During the lifetime of a building or structure, it is critical to know which individuals and companies worked on which projects to permit repairs and routine maintenance to be performed in an efficient and appropriate manner.

Warranty, maintenance, installation and contact information related to, all of the projects performed and products/features installed in and around a building are important for the smooth operation of the building. Almost all equipment installed and maintained on the various floors of a building or other structure also come with user manuals and warranty information that needs to be cataloged for future reference.

Currently, all of the information related to installation, materials, products and warranties at a property are stored in large notebooks. These notebooks are often difficult to search and store due to their voluminous nature. They also can become lost during transport to and from a storage facility. As with any hard copy of records, they are also subject to being inadvertently damaged or destroyed as well.

Hence, there is a need in the art for a convenient to use, inexpensive and efficient system and method that allows for electronic storage and access of information related to the maintenance and operations of a building or other structure.

### SUMMARY OF THE DISCLOSURE

The preferred embodiment of the invention involves a system and method for electronically storing in a database at a server and accessing the database from a user terminal, via a website address, information related to the maintenance and operations of a building or other structure.

The principal object of this invention is to provide a system for electronically storing information related to the maintenance and operation of a building or other structure.

Another object of this invention is to provide a system for electronically accessing information related to the maintenance and operation of a building or other structure.

Another object of this invention is to provide a method for electronically storing information related to the maintenance and operation of a building or other structure.

Another object of this invention is to provide a method for electronically accessing information related to the maintenance and operation of a building or other structure.

Another object of this invention is to provide a system and method that can be updated and modified by end users for electronically storing and accessing information related to the maintenance and operation of a building or other structure.

Another object of this invention is to provide a cost-effective and relatively inexpensive system and method for electronically storing and accessing information related to the maintenance and operation of a building or other structure.

Another object of this invention is to provide a convenient to use system and method for electronically storing and accessing information related to the maintenance and operation of a building or other structure.

Another object of this invention is to provide an efficient to use system and method for electronically storing and accessing information related to the maintenance and operation of a building or other structure.

Another object of this invention is to provide a system and method for electronically storing and accessing information related to the maintenance and operation of a building or other structure that prevents inadvertent damage or destruction of that information.

Another object of this invention is to provide a system and method for electronically storing and accessing information related to the maintenance and operation of a building or other structure that prevents loss of the records containing that information.

Yet another object of this invention is to provide a reliable to use system and method for electronically storing and accessing information related to the maintenance and operation of a building or other structure.

### BRIEF DESCRIPTION OF THE DRAWINGS

FIG. 1 depicts the login webpage used for implementing the preferred embodiment of the invention.

FIG. 2 depicts the projects page used for implementing the preferred embodiment of the invention.

FIG. 3 depicts the selected project page used for implementing the preferred embodiment of the invention.

FIG. 4A depicts the preferred embodiment of the navigable map of the selected site plan.

FIG. 4B depicts the preferred embodiment of the data input in the database related to the selected area of the site plan.

FIG. 5A depicts the preferred embodiment of the navigable map of the selected roof plan.

FIG. 5B depicts the preferred embodiment of the data input in the database related to the selected roof plan.

FIG. 6A depicts the preferred embodiment of the navigable map of the selected elevation plan.

FIG. 6B depicts the preferred embodiment of the data input in the database related to the first floor of the elevation plan.

FIG. 7A depicts the preferred embodiment of the navigable map of the selected floor plan.

FIG. 7B depicts the preferred embodiment of the data input in the database related to the selected area of the floor plan.

### DETAILED DESCRIPTION OF THE DRAWINGS

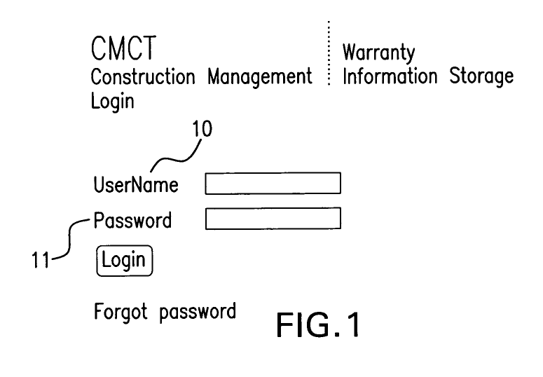

FIG. 1 depicts the login webpage used for implementing the preferred embodiment of the invention. Information related to a property is loaded and stored on a server database accessible at an end user terminal through a website. Examples of a property may include a land area or location, a land area or location containing a feature or improvement such as a building, home or other structure or a proposed or existing building or structure. Entry of the appropriate website address permits a user to access and utilize the login page which contains the traditional lines for user name 10 and a password 11. The password 11 permits access to be restricted and controlled. Having a secured website, in the preferred embodiment, is important to insure only authorized users have access to the detailed information related to the property.

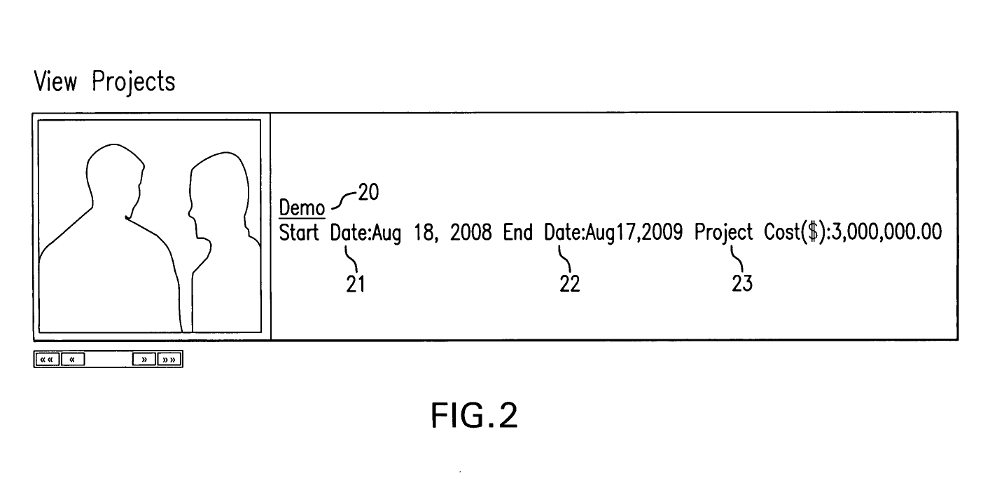

FIG. 2 depicts the projects page used for implementing the preferred embodiment of the invention. The projects page has a list of properties (though only one is shown in FIG. 2) from which an authorized user may select. The properties are listed with a name 20, construction start date 21, construction end date 22 and project cost 23 in this preferred embodiment. A user may select the project name 20 by clicking on the project name 20 which will allow a user to obtain additional information about that particular property.

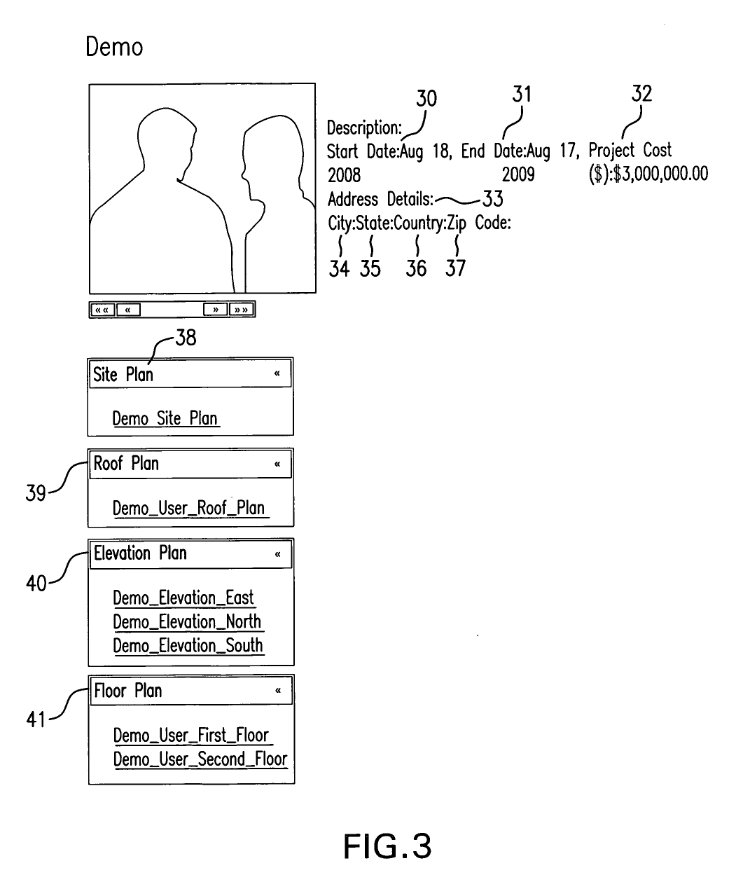

FIG. 3 depicts the selected project page used for implementing the preferred embodiment of the invention. This selected project page shows the construction start date 30, construction end date 31, project cost 32 and address details 33 for the selected property. The address details 33 can also be selected to reveal more lines of information for city 34, state 35, country 36 and zip code 37 of the property.

Additional boxes, tabs or links for the site plan 38, roof plan 39, elevation plan 40 and floor plan 41 are also present. These links or tabs provide detailed information related to the property selected. Within these boxes, a user may select a certain area of a property to view details about that area and/or a navigable map of that area.

In the preferred embodiment, a navigable map can utilize any file format that can be manipulated to permit a user (e.g. end user, administrator) to create areas of interest on an image. The navigable map allows a user to click on/select the image displayed or an area of the image displayed to access a database containing detailed information about that area. In the preferred embodiment, a jpeg or pdf file is manipulated to create areas of interest (e.g. locations, features, products present at a property). Information related to these areas of interest is stored in a database created using an Excel spreadsheet and accessed by selecting the corresponding areas of interest (e.g. location, feature, product) on the navigable map.

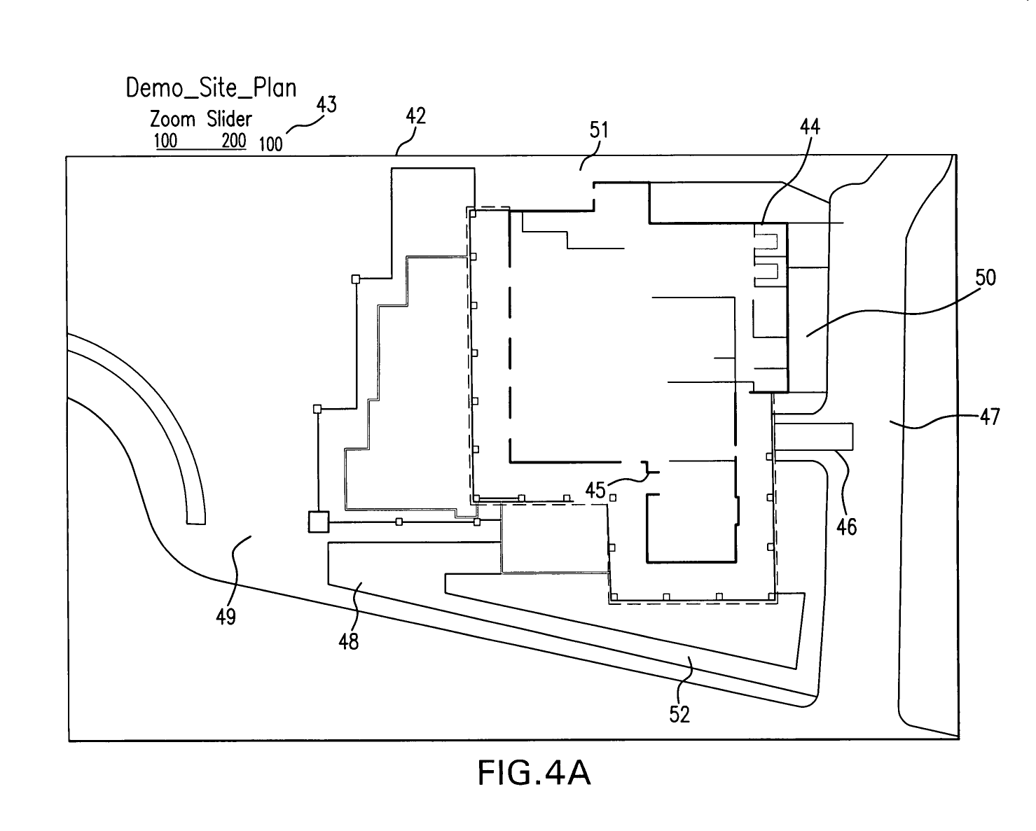

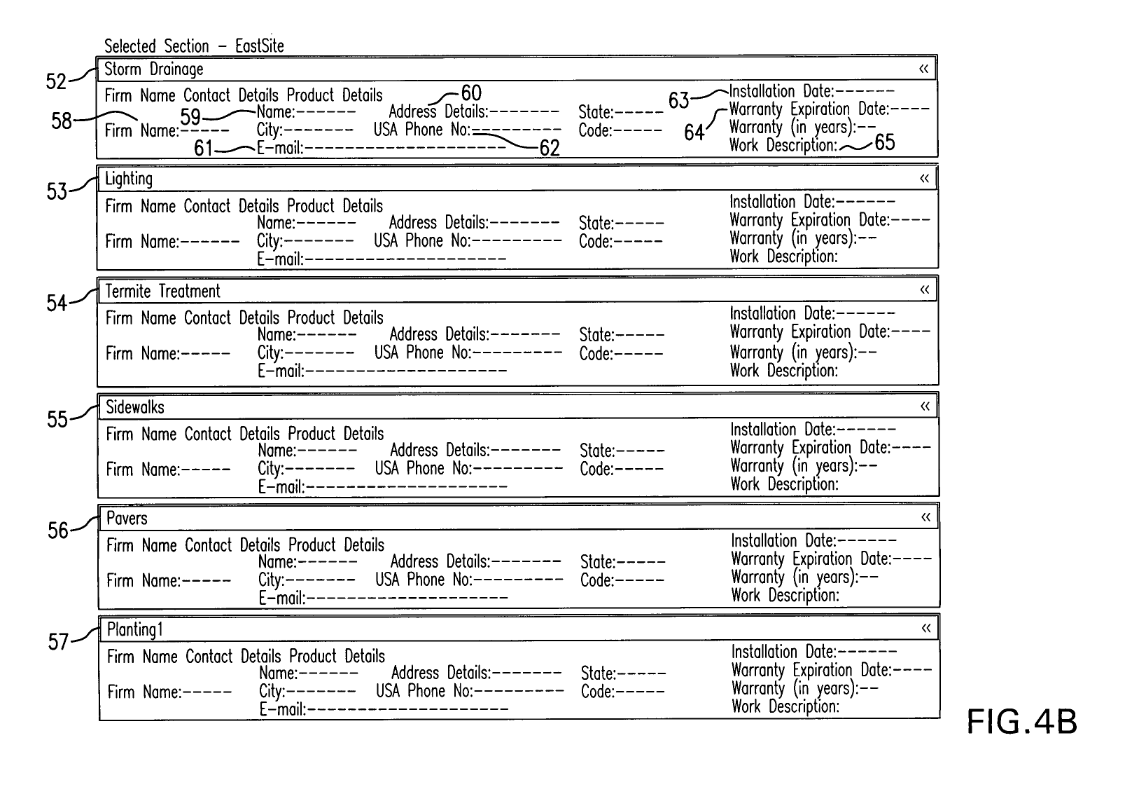

FIG. 4A depicts the preferred embodiment of the selected site plan. The site plan 42 shows a graphical depiction of the property having a building (faculty center 44). A zoom slider 43 is visible at the top of the site plan 42 to show a scale for distances and measurements on the property. The building for the proposed faculty center 44 is shown along with the location of various windows and doors 45, loading docks 46 and other architectural and exterior features.

Additional features such as streets 47 and landscaped areas 48 are also visible around the faculty center 44. A cursor or arrow can be moved over the relevant areas of the property to obtain additional information on certain locations (areas of interest that have been created). For example, the cursor can be moved over the NorthSite 49, SouthSite 50, EastSite 51 or WestSite 52 of the site plan 42 and clicked on to obtain additional information regarding that area of the property at the appropriate location in the database.

In this example, a user moves the cursor/arrow over the EastSite 51 and highlights and clicks on that area of the image to display more information about structures and features located on the EastSite 51 of the property.

FIG. 4B depicts the preferred embodiment of the data input in the database related to the EastSite of the site plan. By clicking on the East Site, additional information on projects or features that have been installed on the. EastSite of a :property (e.g. storm drainage 52, lighting 53, termite treatment 54, sidewalks 55, pavers 56, plantings 57) are shown. Clicking on any of these projects or features causes additional information to appear with contact and product details. These contact and product details may vary but will likely include information such as firm name 58, an individual's name 59, address 60, e-mail address 61, phone number 62, installation date 63 and a warranty expiration date 64 associated with a given project or feature. The warranty expiration date 64 could link to a copy of the actual warranty.

In addition, a work description link 65 contains further details related to product type, equipment location, manufacturer identification number, color and keying information related to a given project or feature. The work description link 65 could also link to a user manual related to a given feature or product.

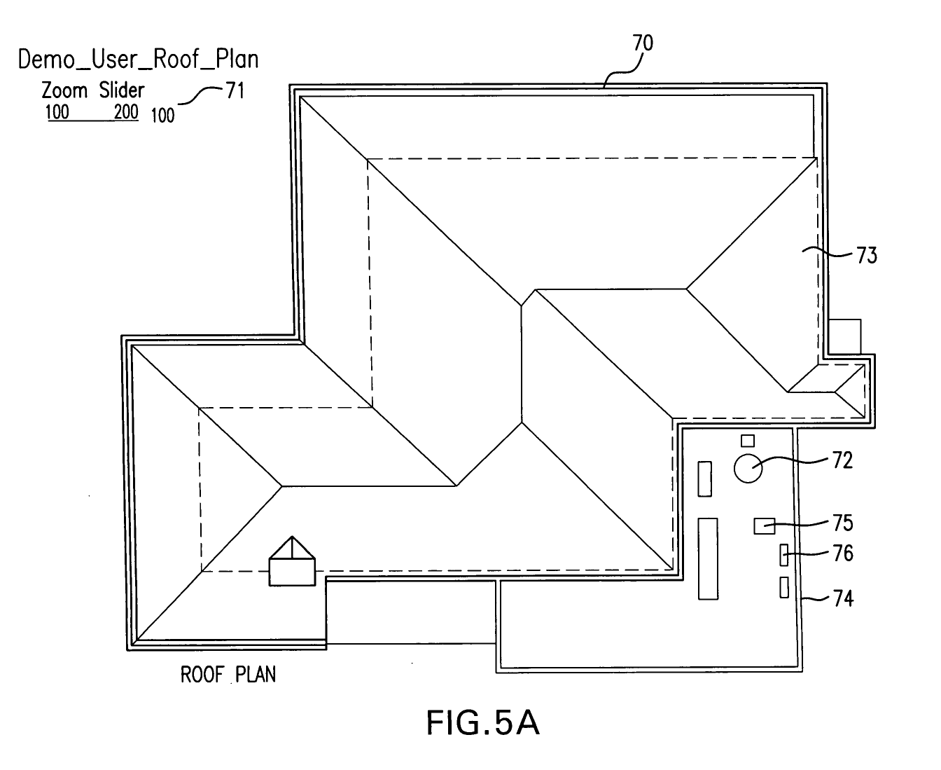

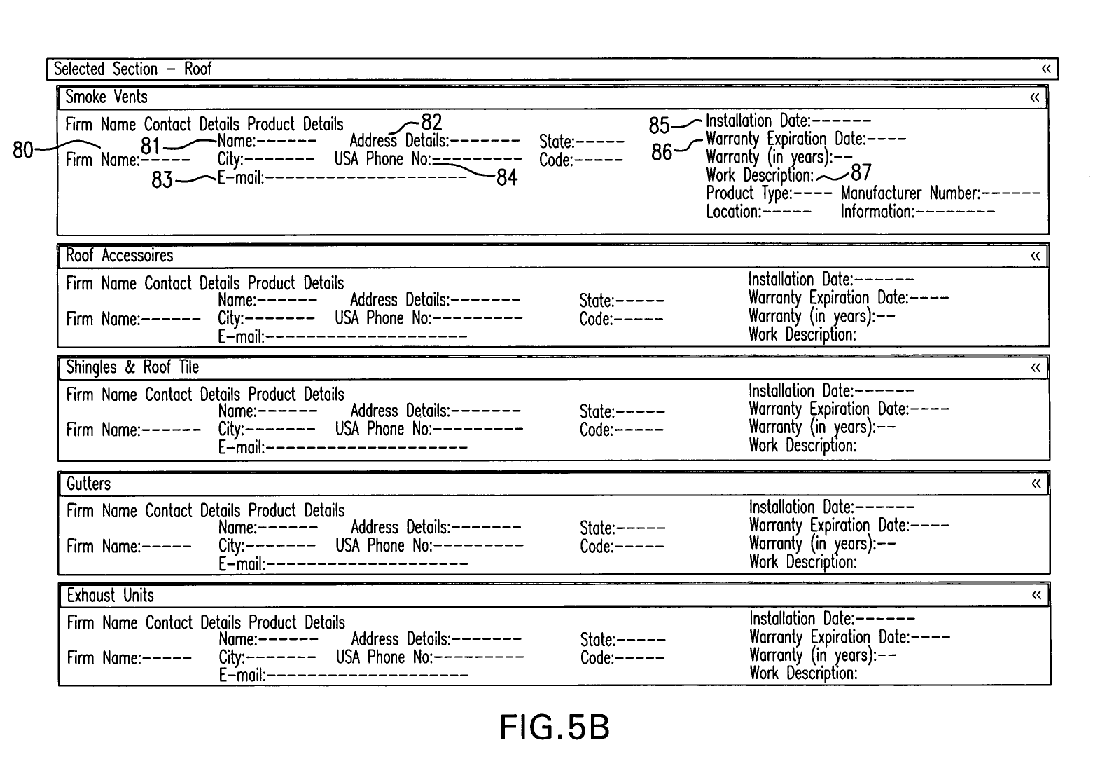

FIG. 5A depicts the preferred embodiment of the navigable map of the selected roof plan. The navigable map of the roof plan 70 shows a graphical depiction of the roof for a faculty center. A zoom slider 71 is visible at the top of the diagram of the roof plan 70 to show a scale for distances on the roof of the faculty center.

Features located on the roof of the faculty center, such as smoke vents 72, roof accessories 76, shingles and roof tile 73, gutters 74 and exhaust units 75, are visible. These are areas of interest created by a user. A cursor or arrow can be moved over the relevant areas of the roof plan 70 to obtain additional information on any given feature by clicking on it. Clicking on any of these features on the roof plan 70 will cause additional information to appear with contact details at the appropriate location of the database. Alternatively, clicking on the roof as a whole (an area of interest created by the user) will cause all information related to all features on the roof to appear in the appropriate location of the database created by the user.

FIG. 5B depicts the preferred embodiment of the data input in the databases related to the selected roof plan. The contact and product details for a selected area or feature (e.g. smoke vents) may vary but will likely include information such as a firm name 80, an individual's name 81, address 82, e-mail address 83, phone number 84, installation date 85 and warranty expiration date 86 associated with that product or feature. Again, the warranty expiration date 86 could link to a copy of the actual warranty for a given product.

In addition, a work description link 87 contains further details related to product type, equipment location, manufacturer identification number, color and keying information related to a given feature or product. The work description link 87 could also link to a copy of the user manual for a given feature or product.

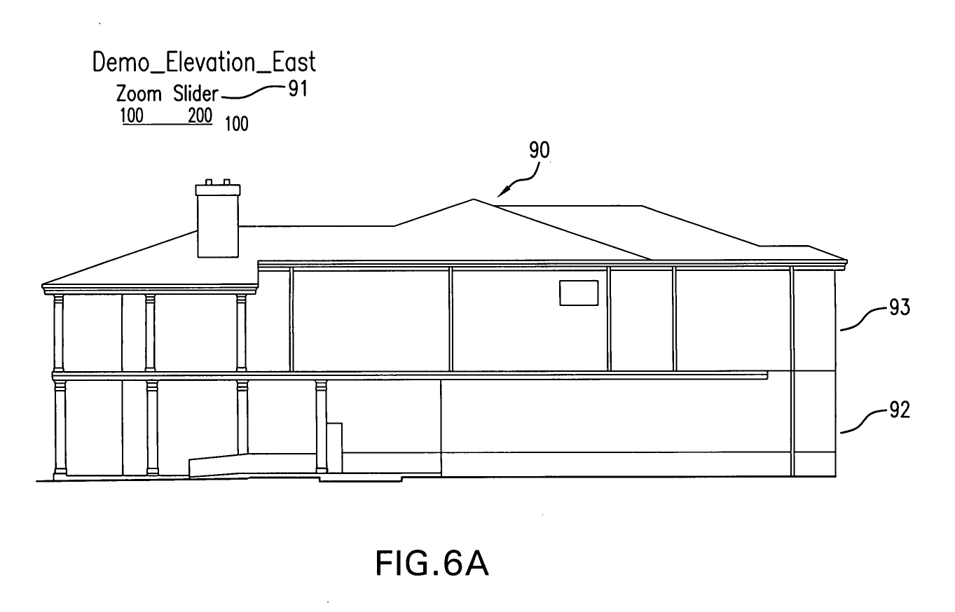

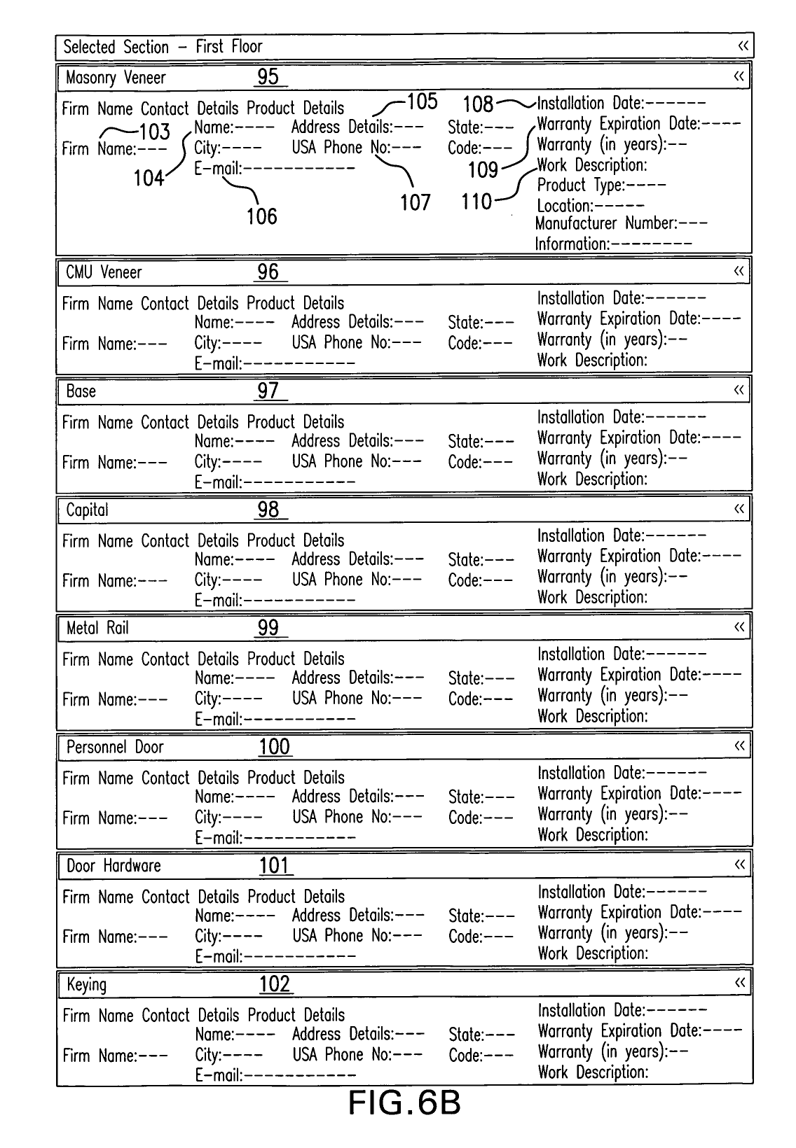

FIG. 6A depicts the preferred embodiment of the navigable map of the selected elevation plan. The navigable map of the elevation plan 90 shows a graphical depiction of the exterior of the levels/floors of the east side of the faculty center located on the property. A zoom slider 91 is visible at the top of the elevation plan 90 to show a scale for distances of the faculty center.

In this example, the proposed faculty center is shown along with the various floors (first floor 92 and second floor 93 are areas of interest created by the user) of the faculty center on the east side of the faculty center (as selected from the different sides of the building in conjunction with the projects page of FIG. 3).

If a user moves the cursor/arrow over the elevation plan 90, he can highlight and click on the image of the first floor (an area of interest created by the user) to display more information about structures and features located on the exterior of that floor on the east side of the faculty center located in the appropriate location of the database as input by the user.

FIG. 6B depicts the preferred embodiment of the data input in the database related to the selected area of the first floor of the elevation plan. Masonry veneer 95, CMU veneer 96, base 97, capital 98, metal rail 99, personnel door 100, door hardware 101, and keying 102 are just some examples of projects or features that have been installed on the exterior, first floor of the east side of the faculty center. Selecting any of these projects or features causes additional information to appear with contact and product details. These contact and product details may vary but will likely include information such as firm name 103, an individual's name 104, address 105, e-mail address 106, phone number 107, installation date 108 and warranty expiration date 109 associated with that feature or product. The warranty expiration date 109 could link to a copy of the actual warranty.

In addition, a work description link 110 contains further details related to product type, equipment location, manufacturer identification number, color and keying information. The work description link 110 could also link to a copy of the user manual for a given feature or product.

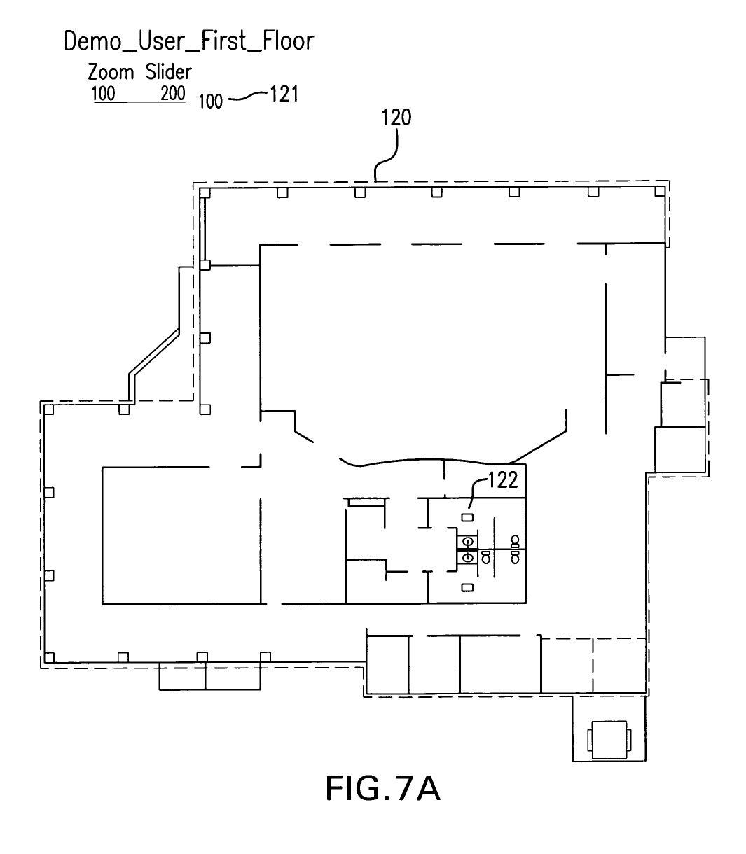

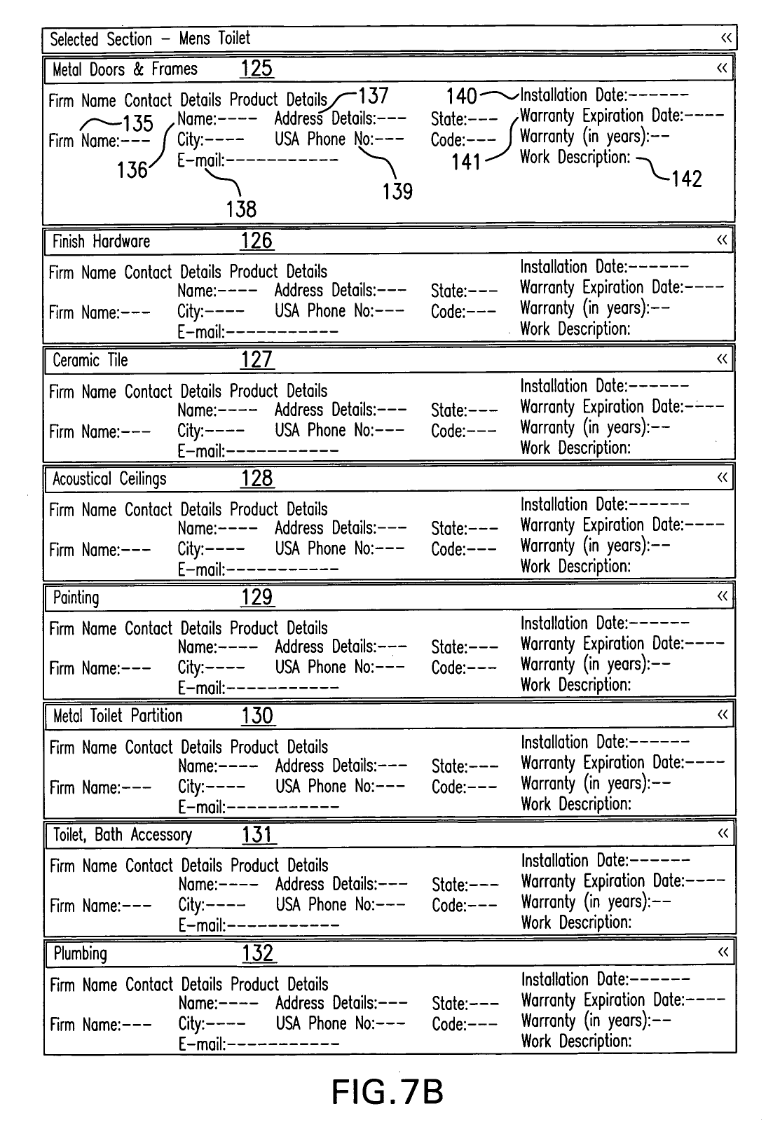

FIG. 7A depicts the preferred embodiment of the navigable map of the selected floor plan. The navigable map of the floor plan 120 shows a graphical depiction of the floor plan of the first floor of the faculty center. Floor plan 120 is selected from a list of floor plans as shown in FIG. 3. A zoom slider 121 is visible at the top of the floor plan 120 to show a scale for distances on the various floors of the faculty center.

When a user selects the first floor from FIG. 3, a floor plan of the first floor appears showing the various rooms and areas of the floor. A cursor, or arrow can be moved over the relevant areas of the floor plan 120 to highlight a specific area and obtain additional information on any given feature or room that has been designated an area of interest by a user by clicking on it. For example, the MensToilet 122 of floor plan 120 can be highlighted and selected to, reveal contact and product details about the various features of the men's bathroom at the appropriate location in the database.

FIG. 7B depicts the preferred embodiment of the data input in the database related to the selected area (MensToilet) of the floor plan. For a men's bathroom, additional details may include information related to features and products such as metal doors and frames 125, finish hardware 126, ceramic tile 127, acoustical ceilings 128, painting 129, metal toilet partitions 130, toilet bath accessory 131 and plumbing 132. The contact and product details may vary but will likely include information such as firm name 135, an individual's name 136, address 137, e-mail address 138, phone number 139, installation date 140 and warranty expiration date 141 related to the features or products. Again, the warranty expiration date 141 could link to a copy of the actual warranty for a given product.

A work description link 142 contains further details related to product type, equipment location, manufacturer identification number, color and keying information. The work description link 142 could also link to a copy of the user manual for a given feature or product.

Use of the described system and method is fairly straightforward. A user (end user, network administrator, construction project manager or any other user) can create navigable maps by manipulating images of site plans, roof plans, elevation plans and floor plans to create areas of interest and can enter the initial corresponding information related to the areas of interest into the appropriate corresponding databases. The areas of interest shown on the navigable maps correspond to locations, features or products at a given property. A user/tenant/building manager of the property can obtain a user name and password to access the databases whenever a repair or specific information on a product or feature at the property is necessary.

The user/tenant/building manager could also be given editing rights to the database to permit him to revise the information in a database whenever a piece of equipment is serviced, replaced or updated.

Although the system and method are described herein in relation to a commercial property, they could be utilized for any type of property. For example, the system and method described herein is also useful for residential applications. It would be equally advantageous for a home builder and home owner to have access to the system and method described herein. For example, a homeowner will often need to access user manuals for the many electronic and mechanical devices and appliances installed in a household. An easily searchable database containing the relevant information on warranties, installation and use of products and features in a house would be invaluable to a homeowner. A navigable site plan, roof plan, elevation plan and floor plan linked to appropriate databases containing the relevant information for homes would also be a useful tool.

Nothing herein is intended to limit the application of this invention to structures of buildings currently under construction. The system and method described herein is useful for any property whether a building, feature or improvement is being planned, currently being built or already has been built.

It is contemplated that the method described herein can be implemented as software, including a computer-readable medium having program instructions executing on a computer, hardware, firmware, or a combination thereof. The method described herein also may be implemented in various combinations on hardware and/or software.

It will be recognized by those skilled in the art that changes or modifications may be made to the above-described embodiments without departing from the broad inventive concepts of the invention. It should therefore be understood that this invention is not limited to the particular embodiments described herein, but is intended to include all changes and modifications that are within the scope and spirit of the invention as set forth in the claims.

What is claimed is:

1. A system for storing and accessing property information comprising:
(a) a server having a database containing information related to a property; and
(b) an end user terminal capable of accessing the server having the database.

2. The system of claim 1 wherein the database is accessible on a secured website that is accessed via a user name and a password at the end user terminal.

3. The system of claim 1 wherein the database can be updated by a user from the end user terminal using a user name and a password.

4. The system of claim 1 wherein the information includes user manuals related to at least one product installed at the property.

5. The system of claim 1 wherein the information includes warranty information related to at least one product or feature installed at the property.

6. The system of claim 1 wherein the information includes installation dates for at least one piece of equipment or feature installed at the property.

7. The system of claim 1 wherein the information includes contact information for a company that installed at least one piece of equipment or feature at the property.

8. The system of claim 1 further comprising:
a navigable map of a site plan for the property accessible at the end user terminal that links to an appropriate location in the database by selecting an area of interest shown on the navigable map of the site plan.

9. The system of claim 1 further comprising:
a navigable map of a roof plan for the property accessible at the end user terminal that links to an appropriate location in the database by selecting an area of interest shown on the navigable map of the roof plan.

10. The system of claim 1 further comprising:
a navigable map of an elevation plan for the property accessible at the end user terminal that links to an appropriate location in the database by selecting an area of interest shown on the navigable map of the elevation plan.

11. The system of claim 1 further comprising:
a navigable map of a floor plan for the property accessible at the end user terminal and that links to an appropriate location in the database by selecting an area of interest shown on the navigable map of the floor plan.

12. A method for storing property information comprising the steps of:
(a) creating a database for storage at a server containing information related to an area of interest at a property; and
(b) creating a navigable map for the property that links to an appropriate location in the database by selecting the area of interest on the navigable map.

13. The method of claim 12 wherein creating the navigable map involves creating a navigable site plan.

14. The method of claim 12 wherein creating the navigable map involves creating a navigable roof plan.

15. The method of claim 12 wherein creating the navigable map involves creating a navigable elevation plan.

16. The method of claim 12 wherein creating the navigable map involves creating a navigable floor plan.

17. The method of claim 12 further comprising the step of:
updating from an end user terminal the database.

18. A method for accessing property information comprising the steps of:
(a) utilizing an end user terminal to access a server that has a database containing information related to a property; and
(b) linking to an appropriate location in the database by selecting at the end user terminal an area of interest on a navigable map.

19. The method of claim 18 wherein the step of linking to an appropriate location in the database by selecting at the end user terminal the area of interest on a navigable map involves selecting at the end user terminal the area of interest on a navigable site plan.

20. The method of claim 18 wherein the step of linking to an appropriate location in the database by selecting at the end user terminal the area of interest on a navigable map involves selecting at the end user terminal the area of interest on a navigable roof plan.

21. The method of claim 18 wherein the step of linking to an appropriate location in the database by selecting at the end user terminal the area of interest on a navigable map involves selecting at the end user terminal the area of interest on a navigable elevation plan.

22. The method of claim 18 wherein the step of linking to an appropriate location in the database by selecting at the end user terminal the area of interest on a navigable map involves selecting at the end user terminal the area of interest on a navigable floor plan.

23. The method of claim 18 further comprising the step of:
utilizing a user name and a password on a website to access the server that has the database.

24. A method of creating a navigable map for a property comprising the step of:
manipulating a file containing an image of a property to create an area of interest on the image wherein the area of interest can be selected to link to an appropriate database containing information about the area of interest.

25. The method of claim 24 wherein manipulating a file involves manipulating a jpeg file.

26. The method of claim 24 wherein manipulating a file involves manipulating a pdf file.
